(19) United States
(12) Patent Application Publication
(10) Pub. No.: US 2012/0013289 A1
(43) Pub. Date: Jan. 19, 2012

(54) FUEL CELL SYSTEM, AND ELECTRIC VEHICLE EQUIPPED WITH THE FUEL CELL SYSTEM

(75) Inventors: Michio Yoshida, Miyoshi-shi (JP); Atsushi Imai, Gamagori-shi (JP); Tomoya Ogawa, Toyota-shi (JP)

(73) Assignee: TOYOTA JIDOSHA KABUSHIKI KAISHA, Toyota-shi (JP)

(21) Appl. No.: 13/259,353

(22) PCT Filed: Mar. 18, 2010
(86) PCT No.: PCT/IB10/00557

§ 371 Date: Sep. 23, 2011

(30) Foreign Application Priority Data
Mar. 31, 2009 (JP) 2009-085112

(51) Int. Cl. H01M 10/46

(52) U.S. Cl. 320/101

(57) ABSTRACT

A fuel cell system starts a fuel cell by setting the voltage supplied to a secondary cell from a voltage transformer at an open-circuit voltage of the fuel cell, and raising the voltage of the fuel cell from a starting voltage to the open-circuit voltage, in the case where the secondary cell is expected to be overcharged if the secondary cell receives electric power. In the case where the secondary cell is not expected to be overcharged if the secondary cell receives electric power, the system starts the fuel cell by setting the voltage supplied from the voltage transformer at a high-potential-avoiding voltage that is lower than the open-circuit voltage of the fuel cell at or after the elapse of a predetermined time following the output of a command to close an FC relay, and raising the voltage of the fuel cell from the starting voltage to the high-potential-avoiding voltage.

### BACKGROUND OF THE INVENTION

1. Field of the Invention

The invention relates to a fuel cell system, and a control that is performed on an electric vehicle equipped with the fuel cell system, at the time of activation of the electric vehicle.

2. Description of the Related Art

Practical application of a fuel cell that supplies hydrogen as a fuel gas to a fuel electrode, and that supplies air as an oxidant gas to an oxidant electrode, and that generates electricity through an electrochemical reaction between hydrogen and oxygen in the air while producing water on an oxidant electrode is now being considered.

In such a fuel cell, if at the time of start of operation, the pressure of hydrogen supplied to the fuel electrode and the pressure of air supplied to the oxidant electrode are about equal to the respective pressures occurring during ordinary operation, it sometimes happens that hydrogen gas and air are unevenly distributed in the fuel electrode and the oxidant electrode, respectively, and the electrodes are degraded by electrochemical reaction caused by the uneven distribution of these gases. Japanese Patent Application Publication No. 2007-26891 (JP-A-2007-26891) discloses a method of preventing the degradation of the electrodes of a fuel cell by causing the pressures of hydrogen and air supplied to the fuel electrode and the oxidant electrode, respectively, at the time of start of operation of the fuel cell to be higher than the ordinary supplied pressures of these gases.

However, if hydrogen gas and air are supplied at high pressure to a fuel cell when the ,fuel cell starts operation, it sometimes happen that the rate of rise of the voltage of the fuel cell becomes large so that the voltage of the fuel cell overshoots its upper-limit voltage. In conjunction with this problem, Japanese Patent Application Publication No. 2007-26891 (JP-A-2007-26891) discloses a method in which when hydrogen gas and air are supplied, at the time of starting a fuel cell, at pressures that are higher than their pressures given during ordinary power generation, output electric power is extracted from the fuel cell, and is put out to a vehicle driving motor, resistors, etc., provided that the voltage of the fuel cell reaches a predetermined voltage that is lower than the upper-limit voltage.

In a fuel cell system mounted in an electric vehicle, an FC relay is provided for turning on and off the connection between the fuel cell and an electric motor. Using the FC relay, the fuel cell is cut off from a load system when the fuel cell is stopped, and the fuel cell is connected to the load system when the fuel cell starts operation. However, there is possibility of the FC relay being welded or damaged if large current flows through the FC relay when the FC relay is closed to connect the fuel cell and the load system.

Therefore, at the time of starting the fuel cell, the voltage of the fuel cell is temporarily raised to an open-circuit voltage to bring about a state in which electric current does not flow out from the fuel cell, before the FC relay is connected.

However, if the voltage of the fuel cell is raised to the open-circuit voltage, there arises a possibility of the high voltage impairing the durability of the fuel cell. Therefore, it is desirable that the voltage of the fuel cell be made lower than the open-circuit voltage.

On the other hand, if the voltage is lowered in this manner, there arises a possibility of the fuel cell performing electricity generation. This electricity generation is not an electricity generation under control, but is an unintended production of power that results from making the voltage lower. Therefore, the thus-generated power is not necessarily consumed entirely by accessories, electric motors, etc., but the energy produced by the electricity generation is likely to be charged substantially entirely into a secondary cell, except for special cases (e.g., when the electric vehicle is started, or the like). Therefore, there is possibility of overcharge of the secondary cell and therefore degradation thereof, depending on the state of charge of the secondary cell.

### SUMMARY OF THE INVENTION

Accordingly, the invention provides a fuel cell system capable of starting the fuel cell without degrading the secondary cell at the time of starting the fuel cell, and also provides an electric vehicle equipped with the fuel cell system.

A fuel cell system in accordance with a first aspect of the invention is a fuel cell system including: a secondary cell that is chargeable and dischargeable; a voltage transformer provided between the secondary cell and a load system; a fuel cell that generates electricity through an electrochemical reaction between a fuel gas and an oxidant gas, and that supplies electric power to the secondary cell and to the load system that shares a common electrical path with the voltage transformer; an FC relay that turns on and off electrical connection between the fuel cell and the common electrical path; and a control portion that controls closing/opening of the FC relay, and voltage of the fuel cell. The control portion includes start means for starting the fuel cell. When the secondary cell is to become overcharged if the secondary cell receives electric power, the start means starts the fuel cell by setting voltage supplied from the voltage transformer at an open-circuit voltage of the fuel cell, and raising the voltage of the fuel cell from a starting voltage to the open-circuit voltage. When the secondary cell is not to become overcharged if the secondary cell receives electric power, the start means starts the fuel cell by setting the voltage supplied from the voltage transformer at a high-potential-avoiding voltage that is lower than the open-circuit voltage of the fuel cell at or after elapse of a predetermined time following output of a command to close the FC relay, and raising the voltage of the fuel cell from the starting voltage to the high-potential-avoiding voltage.

The fuel cell system in accordance with the first aspect may further include charging power restriction value calculation means for calculating a charging power restriction value (Win) of the secondary cell. When the charging power restriction value (Win) calculated is greater than or equal to a predetermined value, the start means may determine that the secondary cell is to become overcharged if the secondary cell receives electric power, and may start the fuel cell by setting the voltage supplied from the voltage transformer at the open-circuit voltage of the fuel cell, and raising the voltage of the fuel cell from the starting voltage to the open-circuit voltage. When the charging power restriction value (Win) calculated is less than the predetermined value, the start means may determine that the secondary cell is not to become overcharged if the secondary cell receives electric power, and may start the fuel cell by setting the voltage supplied from the voltage transformer at the high-potential-avoiding voltage at or after elapse of a predetermined time following output of a command to close the FC relay, and raising the voltage of the fuel cell from the starting voltage to the high-potential-avoiding voltage.

Besides, the fuel cell system in accordance with the first aspect may further include SOC calculation means for calculating state of charge of the secondary cell. When the state of charge calculated is greater than or equal to a predetermined value, the start means may determine that the secondary cell is to become overcharged if the secondary cell receives electric power, and may start the fuel cell by setting the voltage supplied from the voltage transformer at the open-circuit voltage of the fuel cell, and raising the voltage of the fuel cell from the starting voltage to the open-circuit voltage. When the state of charge calculated is less than the predetermined value, the start means may determine that the secondary cell is not to become overcharged if the secondary cell receives electric power, and may start the fuel cell by setting the voltage supplied from the voltage transformer at the high-potential-avoiding voltage at or after elapse of a predetermined time following output of a command to close the FC relay, and raising the voltage of the fuel cell from the starting voltage to the high-potential-avoiding voltage.

Besides, the fuel cell system in accordance with the first aspect may further include voltage detection means for detecting voltage of the secondary cell. When the voltage detected is greater than or equal to a predetermined value, the start means may determine that the secondary cell is to become overcharged if the secondary cell receives electric power, and may start the fuel cell by setting the voltage supplied from the voltage transformer at the open-circuit voltage of the fuel cell, and raising the voltage of the fuel cell from the starting voltage to the open-circuit voltage. When the voltage detected is less than the predetermined value, the start means may determine that the secondary cell is not to become overcharged if the secondary cell receives electric power, and may start the fuel cell by setting the voltage supplied from the voltage transformer at the high-potential-avoiding voltage at or after elapse of a predetermined time following output of a command to close the FC relay, and raising the voltage of the fuel cell from the starting voltage to the high-potential-avoiding voltage.

A fuel cell system in accordance with a second aspect of the invention is a fuel cell system including: a secondary cell that is chargeable and dischargeable; a voltage transformer provided between the secondary cell and a load system; a fuel cell that generates electricity through an electrochemical reaction between a fuel gas and an oxidant gas, and that supplies electric power to the secondary cell and to the load system that shares a common electrical path with the voltage transformer; an FC relay that turns on and off electrical connection between the fuel cell and the common electrical path; and a control portion that controls closing/opening of the FC relay, and voltage of the fuel cell. The control portion includes start means for starting the fuel cell by setting voltage supplied from the voltage transformer at a voltage between an open-circuit voltage of the fuel cell and a high-potential-avoiding voltage that is lower than the open-circuit voltage according to the state of charge of the secondary cell at or after elapse of a predetermined time following output of a command to close the FC relay, and raising the voltage of the fuel cell from a starting voltage to the set voltage.

The fuel cell system in accordance with the second aspect may further include charging power restriction value calculation means for calculating a charging power restriction value (Wᵢₙ) of the secondary cell, and the start means may start the fuel cell by setting the voltage supplied from the voltage transformer at the voltage between the open-circuit voltage of the fuel cell and the high-potential-avoiding voltage that is lower than the open-circuit voltage according to a calculated value of the charging power restriction value (Wᵢₙ) at or after elapse of a predetermined time following output of a command to close the FC relay, and raising the voltage of the fuel cell from the starting voltage to the set voltage.

Besides, the fuel cell system in accordance with the second aspect may further include SOC calculation means for calculating state of charge of the secondary cell, and the start means may start the fuel cell by setting the voltage supplied from the voltage transformer at the voltage between the open-circuit voltage of the fuel cell and the high-potential-avoiding voltage that is lower than the open-circuit voltage according to a calculated value of the state of charge at or after elapse of a predetermined time following output of a command to close the FC relay, and raising the voltage of the fuel cell from the starting voltage to the set voltage.

Besides, the fuel cell system in accordance with the second aspect may further include voltage detection means for detecting voltage of the secondary cell, and the start means may start the fuel cell by setting the voltage supplied from the voltage transformer at the voltage between the open-circuit voltage of the fuel cell and the high-potential-avoiding voltage according to a detected value of the voltage at or after elapse of a predetermined time following output of a command to close the FC relay, and raising the voltage of the fuel cell from the starting voltage to the set voltage.

An electric vehicle in accordance with a third aspect of the invention is an electric vehicle equipped with the fuel cell system according to the foregoing first or second aspect.

According to the invention, when the fuel cell is started, the fuel cell system can be started without degrading the secondary cell.

### BRIEF DESCRIPTION OF THE DRAWINGS

The foregoing and/or further objects, features and advantages of the invention will become more apparent from the following description of example embodiments with reference to the accompanying drawings, in which like numerals are used to represent like elements and wherein:

FIG. 1 is a system diagram of a fuel cell system in an embodiment of the invention;

FIG. 2 is a diagram showing an example of a voltage control performed when the fuel cell system in accordance with the embodiment of the invention starts operating;

FIG. 3 is a diagram showing another example of the voltage control performed when the fuel cell system in accordance with the embodiment of the invention starts operating;

FIG. 4 is a diagram showing a control map of the secondary-side voltage V_{H} with a charging power restriction value Wᵢₙ of the secondary cell, in accordance with the embodiment of the invention; and

FIG. 5 is a diagram showing a control map of the secondary-side voltage V_{H} in the state of charge of the secondary cell, in accordance with the embodiment of the invention.

### DETAILED DESCRIPTION OF EMBODIMENTS

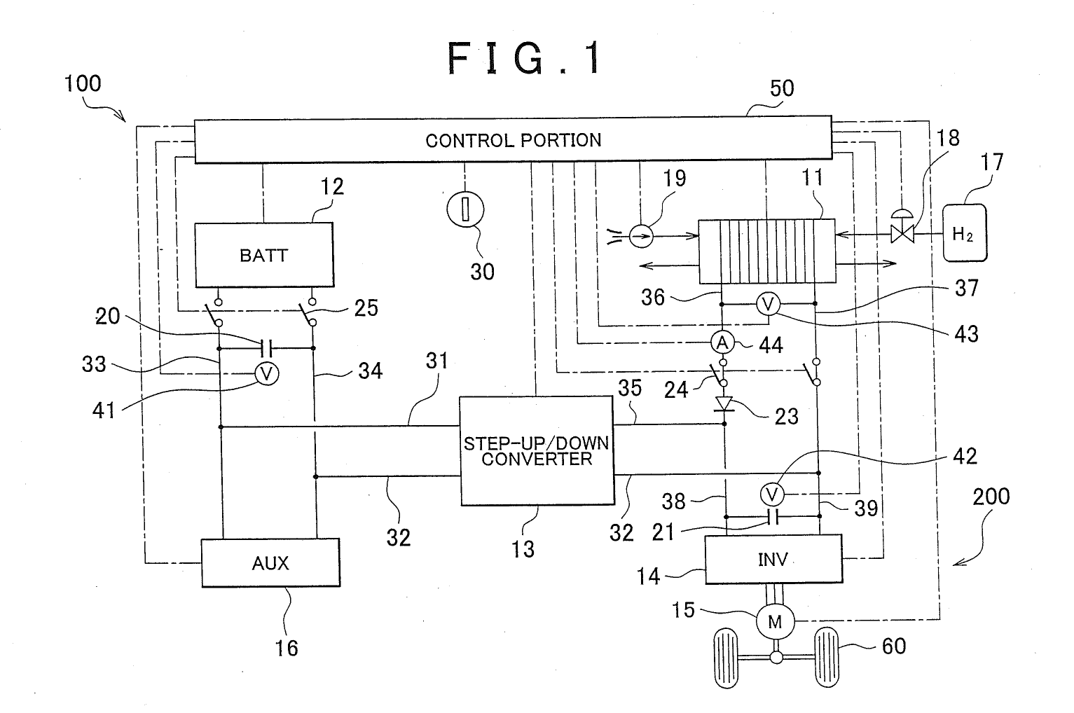

As shown in FIG. 1, a fuel cell system 100 mounted in an electric vehicle 200 includes a chargeable and dischargeable secondary cell 12, a step-up/down voltage converter 13 that raises or lowers the voltage of the secondary cell 12, an inverter 14 that converts direct-current electric power of the step-up/down voltage converter 13 into alternating-current electric power, and supplies the electric power to a traction motor 15, and a fuel cell 11.

The secondary cell 12 is constructed of a chargeable and dischargeable lithium-ion battery, or the like. The voltage of the secondary cell 12 in this embodiment is lower than the drive voltage of the traction motor 15. However, the voltage of the secondary cell is not limited so, but may also be a voltage that is equivalent to or higher than the drive voltage of the traction motor. The step-up/down voltage converter 13 has a plurality of switching elements, and rises a low voltage supplied from the secondary cell 12 into a high voltage for use for driving the traction motor, by on/off-operations of the switching elements. The step-up/down voltage converter 13 is a non-insulated bidirectional DC/DC converter whose reference electrical path 32 is connected to both a minus-side electrical path 34 of the secondary cell 12 and a minus-side electrical path 39 of the inverter 14, and whose primary-side electrical path 31 is connected to a plus-side electrical path 33 of the secondary cell 12, and whose secondary-side electrical path 35 is connected to a plus-side electrical path 38 of the inverter 14. Besides, the plus-side electrical path 33 and the minus-side electrical path 34 of the secondary cell 12 are each provided with a system relay 25 that turns on and off the connection between the secondary cell 12 and a load system.

The fuel cell 11 is supplied with a hydrogen gas, which is a fuel gas, and with air, which is an oxidant gas, and generates electric power through an electrochemical reaction between the hydrogen gas and the oxygen in the air. In the fuel cell 11, the hydrogen gas is supplied from a high-pressure hydrogen tank 17 to a fuel electrode (anode) via a hydrogen supply valve 18, and the air is supplied to an oxidant electrode (cathode) by an air compressor 19. A plus-side electrical path 36 of the fuel cell 11 is connected to the secondary-side electrical path 35 of the step-up/down voltage converter 13 via an FC relay 24 and a blocking diode 23. A minus-side electrical path 37 of the fuel cell 11 is connected to the reference electrical path 32 of the step-up/down voltage converter 13 via another FC relay 24. The secondary-side electrical path 35 of the step-up/down voltage converter 13 is connected to the plus-side electrical path 38 of the inverter 14, and the reference electrical path 32 of the step-up/down voltage converter 13 is connected to the minus-side electrical path 39 of the inverter 14. The plus-side electrical path 36 and the minus-side electrical path 37 of the fuel cell 11 are connected to the plus-side electrical path 38 and the minus-side electrical path 39, respectively, of the inverter 14, via the FC relays 24. The FC relays 24 turn on and off the connection between the load system and the fuel cell 11. When the FC relays 24 are closed, the fuel cell 11 is connected to the secondary side of the step-up/down voltage converter 13, so that the electric power generated by the fuel cell 11 is supplied together with the secondary-side electric power of the secondary cell 12 obtained by raising the voltage of the primary-side electric power of the secondary cell 12, to the inverter, which thereby drives the traction motor 15 that rotates wheels 60. At this time, the voltage of the fuel cell 11 becomes equal to the output voltage of the step-up/down voltage converter 13 and to the input voltage of the inverter 14. Besides, the drive electric power for the air compressor 19, and accessories 16 of the fuel cell 11, such as a cooling water pump, a hydrogen pump, etc., is basically provided by the voltage that is generated by the fuel cell 11. If the fuel cell 11 cannot generate the required electric power, the secondary cell 12 is used as a complement source.

A primary-side capacitor 20 that smoothes the primary-side voltage is connected between the plus-side electrical path 33 and the minus-side electrical path 34 of the secondary cell 12. The primary-side capacitor 20 is provided with a voltage sensor 41 that detects the voltage between the two ends of the primary-side capacitor 20. Besides, a secondary-side capacitor 21 that smoothes the secondary-side voltage is provided between the plus-side electrical path 38 and the minus-side electrical path 39 of the inverter 14. The secondary-side capacitor 21 is provided with a voltage sensor 42 that detects the voltage between the two ends of the secondary-side capacitor 21. The voltage across the primary-side capacitor 20 is a primary-side voltage V_{L} that is the input voltage of the step-up/down voltage converter 13, and the voltage across the secondary-side capacitor 21 is a secondary-side voltage V_{H} that is the output voltage of the step-up/down voltage converter 13. Besides, a voltage sensor 43 that detects the voltage of the fuel cell 11 is provided between the plus-side electrical path 36 and the minus-side electrical path 37 of the fuel cell 11. An electric current sensor 44 that detects the output current from the fuel cell 11 is provided on a plus-side electrical path 36 of the fuel cell 11.

A control portion 50 is a computer that contains a CPU that performs signal processing, and a storage portion that stores programs and control data. The fuel cell 11, the air compressor 19, the hydrogen supply valve 18, the step-up/down voltage converter 13, the inverter 14, the traction motor 15, the accessories 16, the FC relays 24, and the system relays 25 are connected to the control portion 50, and are constructed so as to operate according to commands from the control portion 50. Besides, the secondary cell 12, the voltage sensors 41 to 43, and the electric current sensor 44 are separately connected to the control portion 50, and are constructed so that the state of the secondary cell 12, and detection signals of the voltage sensors 41 to 43 and the electric current sensor 44 are input to the control portion 50. The electric vehicle 200 is provided with an ignition key 30 that is a switch for starting and stopping the fuel cell system 100. The ignition key 30 is connected to the control portion 50, and is constructed so that an on/off-signal of the ignition key 30 is input to the control portion 50.

The control portion 50 is provided with charging power restriction value calculation means for calculating a charging power restriction value Wᵢₙ of the secondary cell 12. The charging power restriction value is calculated, for example, by using the following equations (1) and (2).

Wᵢₙ(t)=SWᵢₙ(t)−Kₚ×{IB(t)−I_{tag1}(t)}−Kᵢ×∫{IB(t)−I_{tag2}(t)}dt (1)

(Wᵢₙ(t) is the charging power restriction value of the secondary cell at time t;
SWᵢₙ(t) is a predetermined for charging power restriction of the secondary cell which is set beforehand;
Kₚ is a p-term feedback gain;
Kᵢ is an i-term feedback gain;
I_{tag1}(t) is a target value in the current restriction by a p-term feedback control; and
IB(t) is a value of electric current of the secondary cell at time t.)

I_{tag}1(t)=Fₚ(Iₗᵢₘ′(t)), and

I_{tag}2(t)=Fᵢ(Iₗᵢₘ′(t)) (2)

(Iₗᵢₘ′(t) is calculated on the basis of a previously calculated permissible charging current value Iₗᵢₘ(t−1) that is previously calculated, or on the basis of a set permissible charging current value Iₗᵢₘ(0) exclusively for the initial calculation.)

The control portion 50 is also provided with SOC calculation means for calculating the state of charge of the secondary cell 12. Signals that are needed in order to calculate the state of charge of the secondary cell 12 are input. The signals that are needed include, for example, an inter-terminal voltage from the voltage sensor 41 disposed between the terminals of the secondary cell 12, a charging-discharging capacity from an electric current sensor (not shown) that is attached to an electric power line connected to an output terminal of the secondary cell 12, a cell temperature from a temperature sensor (not shown) that is attached to the secondary cell 12, etc. Then, the SOC calculation means calculates the state of charge (SOC) by, for example, accumulating the secondary cell current value IB(t) actually measured via an electric power sensor, or accumulating the estimated current value corrected by the actually measured voltage or temperature of the secondary cell.

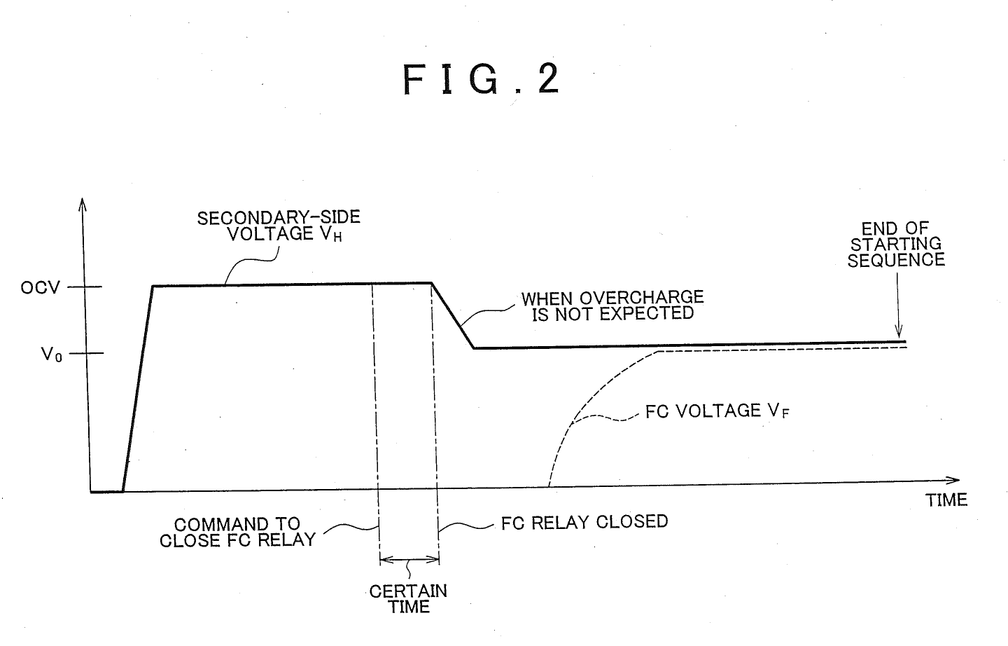

An operation of the fuel cell system 100 in accordance with the embodiment will be described. FIG. 2 is a diagram showing an example of the voltage control performed at the time of starting the fuel cell system in accordance with the embodiment of the invention. In FIG. 2, a solid line shows the secondary-side voltage V_{H}, which is a command voltage of the step-up/down voltage converter 13, and a dotted line shows the FC voltage V_{F}, which is the voltage of the fuel cell 11.

When a driver, that is, an operating person, turns on the ignition key 30, the on-signal from the ignition key 30 is input to the control portion 50. Then, the control portion 50 closes the system relays 25 to connect the secondary cell 12 to the system. After the secondary cell 12 is connected to the system, the primary-side capacitor 20 is charged by the electric power supplied from the secondary cell 12. After the primary-side capacitor is charged, the control portion 50 starts a voltage-raising operation of the step-up/down voltage converter 13 to charge the secondary-side capacitor 21, whereby the secondary-side voltage V_{H} detected by the voltage sensor 42 is raised to the open-circuit voltage OCV (as shown by the solid line in FIG. 2). Incidentally, when the secondary-side voltage V_{H} reaches the open-circuit voltage OCV, the charging of the secondary-side capacitor 21 is completed.

The control portion 50 outputs a command to pressurize a hydrogen system. Due to this command, the hydrogen supply valve 18 opens, so that hydrogen starts to be supplied from the hydrogen tank 17 to the fuel cell 11. When hydrogen is supplied, the pressure at the fuel electrode of the fuel cell 11 rises. However, since the oxidant electrode has not been supplied with air, the electrochemical reaction has not occurred within the fuel cell 11. Incidentally, hydrogen leakage detection may be performed after the hydrogen system starts to be pressurized.

Next, the charging power restriction value calculation means of the control portion 50 calculates the charging power restriction value Wᵢₙ of the secondary cell 12. Besides, the SOC calculation means of the control portion 50 calculates the state of charge of the secondary cell 12. Besides, the voltage sensor 41 detects the voltage of the secondary cell 12.

The control portion 50 determines whether or not the calculated charging power restriction value Wᵢₙ of the secondary cell 12 is greater than or equal to a certain value that is pre-set in the control portion 50. Besides, the control portion 50 determines whether or not the calculated state of charge of the secondary cell 12 is greater than or equal to a certain value that is set beforehand in the control portion 50. Furthermore, the control portion 50 determines whether or not the detected voltage of the secondary cell 12 is greater than or equal to a certain value that is set beforehand in the control portion 50. Then, if at least one of the charging power restriction value Wᵢₙ, the state of charge, and the voltage of the secondary cell 12 is greater than or equal to its corresponding certain value, the control portion 50 determines that the secondary cell 12 will become overcharged if the secondary cell 12 receives electric power. On the other hand, if at last one of the charging power restriction value Wᵢₙ, the state of charge, and the voltage of the secondary cell 12 is less than its corresponding certain value, the control portion 50 determines that the secondary cell 12 is able to receive electric power, that is, the secondary cell 12 will not become overcharged if it receives electric power. It is to be noted herein that it suffices that the certain values set for the charging power restriction value Wᵢₙ, the state of charge and the voltage of the secondary cell 12 are set appropriately for the determination as to whether or not the secondary cell 12 becomes overcharged if it receives electric power.

As shown in FIG. 2, if determining that the secondary cell 12 does not become overcharged if the secondary cell 12 receives electric power, the control portion 50 outputs a command to close the FC relays 24. After or at the elapse of a certain time at which the FC relays 24 become closed due to the command, the control portion 50 decreases the secondary-side voltage V_{H} from the open-circuit voltage OCV to a high-potential-avoiding voltage V₀, and raises the FC voltage V_{F} of the fuel cell 11 from the starting voltage to the high-potential-avoiding voltage V₀. On the other hand, if determining that the secondary cell 12 becomes overcharged if it receives electric power, the control portion 50 outputs the command to close the FC relays 24, but keeps the secondary-side voltage V_{H} at the open-circuit voltage OCV, and supplies hydrogen and oxygen to the fuel cell 11, and thereby raises the FC voltage V_{F} of the fuel cell 11 from the starting voltage to the open-circuit voltage OCV. Although, in FIG. 2, the starting voltage of the fuel cell 11 is zero, the starting voltage of the fuel cell 11 varies according to the operation stop time of the fuel cell 11, that is, the starting voltage becomes closer to zero the longer the operation stop time, and the starting voltage becomes higher the shorter the operation stop time. Besides, the high-potential-avoiding voltage V₀ means a pre-determined operation voltage that is less than the open-circuit voltage OCV, and that can be generated by the fuel cell 11, so that durability of the fuel cell 11 will be certainly maintained

If the secondary-side voltage V_{H} is lowered from the open-circuit voltage OCV to the high-potential-avoiding voltage V₀ at the time of starting the fuel cell 11, the fuel cell 11 sometimes generates electricity. This electricity generation is not an electricity generation under control, but is an unintended production of power that results from making the voltage lower. Therefore, the thus-generated power is not necessarily consumed entirely by accessories, electric motors, etc., but the energy produced by the electricity generation is likely to be charged substantially entirely into a secondary cell, except for special cases (e.g., when the electric vehicle is started, or the like). Hence, in the embodiment, in the case where the secondary cell 12 is expected to become overcharged if it receives electric power, the secondary-side voltage V_{H} is kept at the open-circuit voltage OCV, so that current does not flow out from the fuel cell. This prevents overcharge of the secondary cell, and therefore prevents the degradation of the secondary cell caused by overcharge.

Besides, if at the time of starting the fuel cell 11, the FC relays 24 are closed to connect the fuel cell 11 and the load system after the secondary-side voltage V_{H} is lowered from the open-circuit voltage OCV to the high-potential-avoiding voltage V₀, large current sometimes flow through the FC relays 24. If that happens, the FC relays 24 become fused, or damaged. Therefore, in this embodiment, the FC relays 24 are closed to connect the fuel cell 11 and the load system, while the secondary-side voltage V_{H} is equal to the open-circuit voltage OCV, at which current does not flow out from the fuel cell 11. After that, the secondary-side voltage V_{H} is lowered from the open-circuit voltage OCV to the high-potential-avoiding voltage V₀. This prevents fusing and damaging the FC relays 24.

The control portion 50 outputs a command to start the air compressor 19, after starting the pressurization of the hydrogen system, connecting the FC relays 24, and JO adjusting the secondary-side voltage V_{H} on the basis of the state of charge of the secondary cell 12. Due to this command, the air compressor 19 is started, so that air starts to be supplied to the fuel cell 11. Incidentally, the timing of starting the pressurization of the hydrogen system, and the timing of starting the air compressor 19 are not restricted by the foregoing description. For example, it is also permissible to start the pressurization of the hydrogen system and start the air compressor 19 after connecting the FC relays 24, and adjusting the secondary-side voltage V_{H} on the basis of the state of charge of the secondary cell 12.

After the air compressor 19 is started and therefore air begins to be supplied to the fuel cell 11, the electrochemical reaction between the hydrogen and the oxygen in the air begins within the fuel cell 11, so that the FC voltage V_{F} of the fuel cell 11 detected by the voltage sensor 43 gradually rises from the starting voltage as shown by the dotted line in FIG. 2. Then, the FC voltage V_{F} of the fuel cell 11 reaches the high-potential-avoiding voltage V₀ in the case where the secondary cell 12 does not become overcharged if it receives electric power. In the case where the secondary cell 12 does not become overcharged if it receives electric power, the secondary-side voltage V_{H}, which is the output voltage of the step-up/down voltage converter 13, has been set at the high-potential-avoiding voltage V₀, so that the FC voltage V_{F} of the fuel cell 11 is also held at the high-potential-avoiding voltage V₀, and does not rise to the open-circuit voltage OCV. On the other hand, in the case where the secondary cell 12 becomes overcharged if it receives electric power, the secondary-side voltage V_{H}, which is the output voltage of the step-up/down voltage converter 13, is kept at the open-circuit voltage OCV, so that the FC voltage V_{F} of the fuel cell 11 rises to the open-circuit voltage OCV. Then, the control portion 50 assumes that the starting of the fuel cell 11 has been completed, and shifts to the ordinary operation. Incidentally, the fuel cell 11 has a characteristic that the output current gradually decreases with the rising of the FC voltage V_{F} to the open-circuit voltage OCV, and becomes zero when the FC voltage VF reaches the open-circuit voltage OCV.

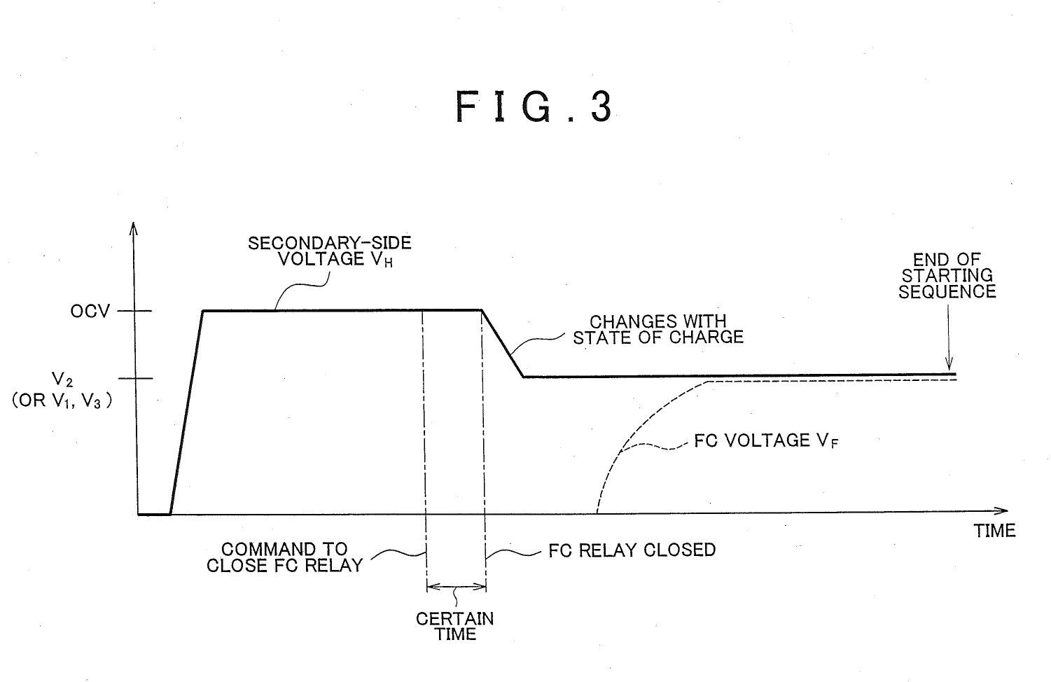

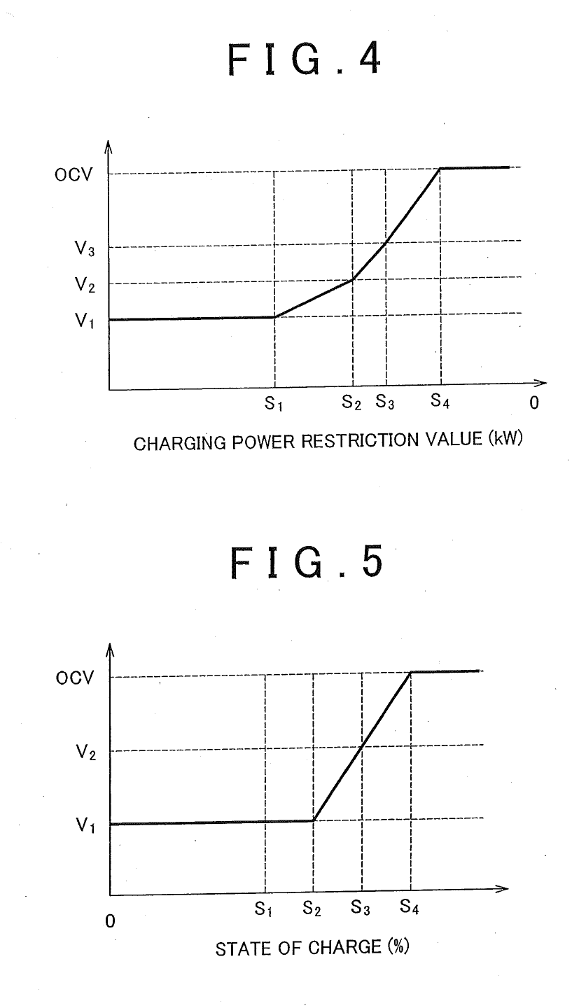

Next, another example of an operation of the fuel cell system 100 in accordance with an embodiment of the invention will be described. FIG. 3 is a diagram showing another example of the voltage control performed at the time of starting the fuel cell system in accordance with the embodiment of the invention. FIG. 4 is a diagram showing a control map of the secondary-side voltage V_{H} at the charging power restriction value Wᵢₙ of the secondary cell in accordance with the embodiment of the invention. FIG. 5 is a diagram showing a control map of the secondary-side voltage V_{H} at the state of charge of the secondary cell in accordance with the embodiment of the invention.

As described above, after the secondary-side voltage V_{H}, which is the output voltage of the step-up/down voltage converter 13, is raised to the open-circuit voltage OCV (as shown by the upper solid line in FIG. 2), the supply of hydrogen from the hydrogen tank 17 to the fuel cell 11 is started.

Next, the charging power restriction value calculation means of the control portion 50 calculates a charging power restriction value Wᵢₙ of the secondary cell 12. Besides, the SOC calculation means of the control portion 50 calculates a state of charge of the secondary cell 12. Besides, the voltage sensor 41 detects the voltage of the secondary cell 12.

The control portion 50 sets the secondary-side voltage V_{H} by placing the calculated charging power restriction value Wᵢₙ of the secondary cell 12 on the control map shown in FIG. 4. Besides, the control portion 50 may also set the secondary-side voltage V_{H} by placing the calculated state of charge of the secondary cell 12 on the control map shown in FIG. 5. Furthermore the control portion 50 may also set the secondary-side voltage V_{H} by placing the detected secondary cell 12 on the control map of the secondary-side voltage V_{H} at the voltage of the secondary cell 12 (not shown). In this embodiment, it suffices that the secondary-side voltage V_{H} is set according to at least one of the charging power restriction value Wᵢₙ, the state of charge, and the voltage of the secondary cell 12.

Then, the control portion 50 outputs a command to close the FC relays 24. After or at the elapse of a certain time at which the FC relays become closed due to this command, the control portion 50 changes the secondary-side voltage V_{H} from the open-circuit voltage OCV to the value that is set as described above. For example, in the case where the charging power restriction value is S₂, the placement of the value on the control map shown in FIG. 4 gives V₂ as a value of the secondary-side voltage V_{H} that is to be set. After or at the elapse of the certain time at which the FC relays 24 become closed, the control portion 50 changes the secondary-side voltage V_{H} from the open-circuit voltage OCV to the value V₂. Then, the control portion 50 raises the voltage of the fuel cell 11 from the starting voltage to the value V₂ as described later.

When the fuel cell 11 is started, the secondary-side voltage V_{H} is decreased from the open-circuit voltage OCV to a voltage commensurate with the state of charge of the secondary cell 12. Therefore, even in the case where the fuel cell 11 conducts electricity generation, the fuel cell 11 generates only an amount of power that the secondary cell 12 is able to receive. This prevents overcharge of the secondary cell 12, and therefore restrains the degradation of the secondary cell 12 caused by overcharge.

Besides, in this embodiment, after the FC relays 24 are closed to connect the fuel cell 11 and the load system, the secondary-side voltage V_{H} is decreased from the open-circuit voltage OCV to a voltage that is set according to the state of charge of the secondary cell 12. Therefore, the fusing and damaging of the FC relays 24 can be prevented.

The control portion 50 outputs the command to start the air compressor 19, after starting the pressurization of the hydrogen system, connecting the FC relays 24, and adjusting the secondary-side voltage V_{H} on the basis of the state of charge of the secondary cell 12. Due to this command, the air compressor 19 is started, so that air starts to be supplied to the fuel cell 11. Incidentally, the timing of starting the pressurization of the hydrogen system, and the timing of starting the air compressor 19 are not restricted by the foregoing description. For example, it is also permissible to start the pressurization of the hydrogen system and start the air compressor 19 after connecting the FC relays 24, and adjusting the secondary-side voltage V_{H} on the basis of the state of charge of the secondary cell 12.

After the air compressor 19 is started and therefore air begins to be supplied to the fuel cell 11, the electrochemical reaction between the hydrogen and the oxygen in the air begins within the fuel cell 11, so that the FC voltage V_{F} of the fuel cell 11 detected by the voltage sensor 43 gradually rises from the starting voltage as shown by the dotted line in FIG. 3. Then, the FC voltage V_{F} of the fuel cell 11 reaches the secondary-side voltage V_{H} (e.g., V₂ shown in FIG. 3) that is set according to the state of charge of the secondary cell 12. Then, the control portion 50 assumes that the starting of the fuel cell 11 has been completed, and shifts to the ordinary operation.

As described above, in the embodiment, when the fuel cell is started, the voltage of the fuel cell is made higher than the high-potential-avoiding voltage to restrict the output current of the fuel cell, depending on the state of charge of the secondary cell. Due to this, when the fuel cell is started, the overcharge of the secondary cell due to the electric power supplied from the fuel cell is restrained, so that the degradation of the secondary cell caused by overcharge can be restrained.

While the invention has been described with reference to example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

1. A fuel cell system comprising:
a secondary cell that is chargeable and dischargeable;
a voltage transformer provided between the secondary cell and a load system;
a fuel cell that generates electricity through an electrochemical reaction between a fuel gas and an oxidant gas, and that supplies electric power to the secondary cell and to the load system that shares a common electrical path with the voltage transformer;
an FC relay that turns on and off electrical connection between the fuel cell and the common electrical path; and
a control portion that controls closing/opening of the FC relay, and voltage of the fuel cell, wherein:
the control portion includes a start portion that starts the fuel cell; after said control portion has raised a voltage supplied from the voltage transformer to an open-circuit voltage of the fuel cell, when the secondary cell is to become overcharged if the secondary cell receives electric power, the start portion starts the fuel cell by setting voltage supplied from the voltage transformer at said open-circuit voltage of the fuel cell, and raising the voltage of the fuel cell from a starting voltage to the open-circuit voltage; and when the secondary cell is not to become overcharged if the secondary cell receives electric power, the start portion starts the fuel cell by setting the voltage supplied from the voltage transformer at a high-potential-avoiding voltage that is lower than the open-circuit voltage of the fuel cell and raising the voltage of the fuel cell from the starting voltage to the high-potential-avoiding voltage, at or after elapse of a predetermined time following output of a command to close the FC relay, at which the FC relays become closed.

2. The fuel cell system according to claim 1, further comprising
a charging power restriction value calculation portion that calculates a charging power restriction value of the secondary cell,
wherein:
when the charging power restriction value calculated is greater than or equal to a predetermined value, the start portion determines that the secondary cell is to become overcharged if the secondary cell receives electric power, and starts the fuel cell by setting the voltage supplied from the voltage transformer at the open-circuit voltage of the fuel cell, and raising the voltage of the fuel cell from the starting voltage to the open-circuit voltage; and
when the charging power restriction value calculated is less than the predetermined value, the start portion determines that the secondary cell is not to become overcharged if the secondary cell receives electric power, and starts the fuel cell by setting the voltage supplied from the voltage transformer at the high-potential-avoiding voltage at or after elapse of a predetermined time following output of a command to close the FC relay, and raising the voltage of the fuel cell from the starting voltage to the high-potential-avoiding voltage.

3. The fuel cell system according to claim 1, further comprising
a SOC calculation portion that calculates state of charge of the secondary cell,
wherein:
when the state of charge calculated is greater than or equal to a predetermined value, the start portion determines that the secondary cell is to become overcharged if the secondary cell receives electric power, and starts the fuel cell by setting the voltage supplied from the voltage transformer at the open-circuit voltage of the fuel cell, and raising the voltage of the fuel cell from the starting voltage to the open-circuit voltage; and
when the state of charge calculated is less than the predetermined value, the start portion determines that the secondary cell is not to become overcharged if the secondary cell receives electric power, and starts the fuel cell by setting the voltage supplied from the voltage transformer at the high-potential-avoiding voltage at or after elapse of a predetermined time following output of a command to close the FC relay, and raising the voltage of the fuel cell from the starting voltage to the high-potential-avoiding voltage.

4. The fuel cell system according to claim 1, further comprising
a voltage detection portion that detects voltage of the secondary cell, wherein:
when the voltage detected is greater than or equal to a predetermined value, the start portion determines that the secondary cell is to become overcharged if the secondary cell receives electric power, and starts the fuel cell by setting the voltage supplied from the voltage transformer at the open-circuit voltage of the fuel cell, and raising the voltage of the fuel cell from the starting voltage to the open-circuit voltage; and
when the voltage detected is less than the predetermined value, the start portion determines that the secondary cell is not to become overcharged if the secondary cell receives electric power, and starts the fuel cell by setting the voltage supplied from the voltage transformer at the high-potential-avoiding voltage at or after elapse of a predetermined time following output of a command to close the FC relay, and raising the voltage of the fuel cell from the starting voltage to the high-potential-avoiding voltage.

5. A fuel cell system comprising:
a secondary cell that is chargeable and dischargeable;
a voltage transformer provided between the secondary cell and a load system;
a fuel cell that generates electricity through an electrochemical reaction between a fuel gas and an oxidant gas, and that supplies electric power to the secondary cell and to the load system that shares a common electrical path with the voltage transformer;
an FC relay that turns on and off electrical connection between the fuel cell and the common electrical path; and
a control portion that controls closing/opening of the FC relay, and voltage of the fuel cell, wherein the control portion includes a start portion that starts the fuel cell; after said control portion has raised a voltage supplied from the voltage transformer to an open-circuit voltage of the fuel cell, setting voltage supplied from the voltage transformer at a voltage between an open-circuit voltage of the fuel cell and a high-potential-avoiding voltage that is lower than the open-circuit voltage according to the state of charge of the secondary cell and raising the voltage of the fuel cell from a starting voltage to the set voltage, at or after elapse of a predetermined time following output of a command to close the FC relay, at which the FC relays become closed.

6. The fuel cell system according to claim 5 further comprising
a charging power restriction value calculation portion that calculates a charging power restriction value of the secondary cell,
wherein
the start portion starts the fuel cell by setting the voltage supplied from the voltage transformer at the voltage between the open-circuit voltage of the fuel cell and the high-potential-avoiding voltage according to a calculated value of the charging power restriction value at or after elapse of a predetermined time following output of a command to close the FC relay, and raising the voltage of the fuel cell from the starting voltage to the set voltage.

7. The fuel cell system according to claim 5, further comprising
a SOC calculation portion that calculates state of charge of the secondary cell,
wherein
the start portion starts the fuel cell by setting the voltage supplied from the voltage transformer at the voltage between the open-circuit voltage of the fuel cell and the high-potential-avoiding voltage according to a calculated value of the state of charge at or after elapse of a predetermined time following output of a command to close the FC relay, and raising the voltage of the fuel cell from the starting voltage to the set voltage.

8. The fuel cell system according to claim 5, further comprising
a voltage detection portion that detects voltage of the secondary cell,
wherein
the start portion starts the fuel cell by setting the voltage supplied from the voltage transformer at the voltage between the open-circuit voltage of the fuel cell and the high-potential-avoiding voltage according to a detected value of the voltage at or after elapse of a predetermined time following output of a command to close the FC relay, and raising the voltage of the fuel cell from the starting voltage to the set voltage.

9. An electric vehicle equipped with the fuel cell system according to claim 1.

10. An electric vehicle equipped with the fuel cell system according to claim 5.
